(19) United States
(12) Patent Application Publication
(10) Pub. No.: US 2010/0193437 A1
(43) Pub. Date: Aug. 5, 2010

(54) FLUID TREATMENT ELEMENTS AND FLUID TREATMENT ARRANGEMENTS WITH FLUID TREATMENT ELEMENTS HAVING DIFFERENT FLUID TREATEMENT CHARACTERISTICS AND METHODS FOR MAKING AND USING THEM

(75) Inventors: Thomas Welch, JR., Homer, NY (US); Mark F. Hurwitz, Ithaca, NY (US); Tanweer ul Haq, Tully, NY (US); Joseph Verschneider, Cortland, NY (US)

Correspondence Address: LEYDIG VOIT & MAYER, LTD, 700 THIRTEENTH ST. NW, SUITE 300, WASHINGTON, DC, 20005-3960, US

(73) Assignee: PALL CORPORATION, Port Washington, NY (US)

(21) Appl. No.: 12/531,704

(22) PCT Filed: Mar. 14, 2008
(86) PCT No.: PCT/US2008/057016

§ 371 Date: Apr. 14, 2010

Related U.S. Application Data
(60) Provisional application No. 60/907,069, filed on Mar. 19, 2007.

(51) Int. Cl. B01D 63/10; B29C 53/60

(52) U.S. Cl. 210/650; 210/321.74; 264/103

(57) ABSTRACT

Fluid treatment arrangements and elements and methods for making and using fluid treatment arrangements and elements are disclosed. A ribbon including a permeable fluid treatment medium may be spirally wound in a plurality of windings to form a fluid treatment element having a disk-shaped body. At least two and as many as many as fifty or more fluid treatment elements may be positioned along a core assembly with spaces between at least some of the adjacent fluid treatment elements to form a fluid treatment arrangement. For some embodiments, fluid flowing between the exterior of the fluid treatment arrangement and the interior of the core assembly may flow through a permeable fluid treatment medium having a first fluid treatment characteristic and a permeable fluid treatment medium having a different second fluid treatment characteristic. For some embodiments, fluid flowing between the exterior of the fluid treatment arrangement and the interior of the core assembly may flow through a fluid treatment element having a first fluid treatment characteristic and a functional material having a different second fluid treatment characteristic.

This application claims priority based on U.S. Provisional Application No. 60/907,069, which was filed on Mar. 19, 2007, and is incorporated by reference.

### DISCLOSURE OF THE INVENTION

The present invention relates to fluid treatment arrangements and fluid treatment elements and methods for making and using them. In particular, the present invention relates to fluid treatment arrangements and methods for making and using fluid treatment arrangements which include one or more spirally wound fluid treatment elements. A fluid treatment element may be fashioned by spirally winding a ribbon in a plurality of windings to form a generally disk-shaped body. The ribbon may include a long, narrow strip of a permeable fluid treatment medium having first and second opposite major surfaces and first and second opposite side edges. The disk-shaped body may have an end surface which faces in one direction, another end surface which faces in the opposite direction, and an outer rim. To form a fluid treatment arrangement, several of these fluid treatment elements may be positioned along a hollow core assembly with a space between at least some of the elements.

A fluid may be directed through a fluid treatment element, i.e., from one end surface to the opposite end surface of the fluid treatment element. The fluid may enter one end surface of the fluid treatment element from one space adjacent to the end surface and/or the fluid may exit the other end surface of the fluid treatment element to another space adjacent to the other end surface. As the fluid passes through the fluid treatment element, the fluid may pass generally edgewise through the permeable fluid treatment medium of each winding, i.e., the fluid may flow generally laterally within the permeable medium generally parallel to the first and second opposite major surfaces. For example, the fluid may enter the permeable medium through one side edge of the ribbon, flow laterally within the permeable medium to the opposite edge of the ribbon, and exit the permeable medium through the opposite side edge. As the fluid passes through the fluid treatment element, the fluid may also flow radially from the permeable fluid treatment medium of one winding into and then laterally along the permeable medium of one or more adjacent or nearby windings.

Fluid treatment arrangements embodying one or more aspects of the invention may be used to treat fluids, including gases, liquids, or mixtures of gases, liquids, and/or solids. As the fluid passes through the fluid treatment element, the fluid may be treated in any of numerous ways, depending on the fluid treatment characteristic of the fluid treatment element, and there are many different fluid treatment characteristics. For example, the fluid treatment characteristic may relate to a pore structure or a removal rating of the fluid treatment medium which retards or prevents passage of particulates or molecules above a certain size and filters these particulates or molecules from the fluid as the fluid flows through the fluid treatment element. As another example, the fluid treatment characteristic may relate to a chemical or biochemical agent on or in the fluid treatment medium which binds to one or more substances, e.g., molecules, proteins, and/or nucleic acids, in the fluid and separates these substances from the fluid as the fluid flows through the fluid treatment element. As yet another example, the fluid treatment characteristic may relate to a sorbent material in or on the fluid treatment medium which absorbs or adsorbs one or more substances, e.g., molecules or compounds, from the fluid and separates these substances from the fluid as the fluid flows through the fluid treatment element. As a further example, the fluid treatment characteristic may relate to a surface chemistry of the fluid treatment medium which aggregates small droplets of liquid entrained in the fluid and produces larger droplets that may be more easily removed from the fluid.

### SUMMARY OF THE INVENTION

In accordance with one aspect of the invention, fluid treatment arrangements may comprise a hollow core assembly, at least first and second fluid treatment elements mounted along the core assembly, and a fluid flow path through the first and second fluid treatment elements. The core assembly has an interior and an axis. Each fluid treatment element includes a ribbon which has a permeable fluid treatment medium, and the ribbon is spirally wound in a plurality of windings to define a generally disk-shaped body which has a radial dimension. The disk-shaped body also has a first end surface on one side of the body, a second end surface on the other side of the body, and an outer rim. The first fluid treatment element has a first fluid treatment characteristic, and the second fluid treatment element has a second fluid treatment characteristic which is different from the first fluid treatment characteristic. The fluid flow path extends between the first and second end surfaces of both fluid treatment elements generally edgewise through the permeable fluid treatment media to or from the interior of the core assembly.

In accordance with another aspect of the invention, fluid treatment arrangements may comprise a hollow core assembly and a plurality of disk-shaped fluid treatment elements. The hollow core assembly has an interior and an axis. Each fluid treatment element includes a ribbon which has at least one strip of a permeable fluid treatment medium having first and second opposite side edges. The ribbon is spirally wound in a plurality of windings and defines a first axially-facing end surface comprising the plurality of windings of the first side edge of the permeable fluid treatment medium strip, a second axially-facing end surface comprising the plurality of windings of the second side edge of the permeable fluid treatment medium strip, and an outer rim. The plurality of fluid treatment elements includes a plurality of first fluid treatment elements having a first fluid treatment characteristic and a plurality of second fluid treatments having a second fluid treatment characteristic which is different from the first fluid treatment characteristic. The fluid treatment elements are positioned along the core assembly to define a plurality of spaces between at least some adjacent fluid treatment elements. The plurality of spaces include a plurality of first spaces which open directly into the interior of the core assembly and a plurality of second spaces which open directly onto the exterior of the fluid treatment arrangement.

In accordance with another aspect of the invention, methods for making a fluid treatment arrangement may comprise positioning a first spirally wound, disk-shaped fluid treatment element and a second spirally wound, disk-shaped fluid treatment element along a hollow core assembly. The first fluid treatment element has a first fluid treatment characteristic and the second fluid treatment element has a second fluid treatment characteristic which is different from the first fluid treatment characteristic. Positioning the first and second fluid treatment elements along the core assembly includes arranging the first and second fluid treatment elements in a fluid flow path which extends generally edgewise through the windings of the first and second fluid treatment elements in series to or from the interior of the core assembly.

In accordance with another aspect of the invention, fluid treatment elements may comprise a ribbon spirally wound in a plurality of windings to define a generally disk-shaped body having a radial dimension, a first end surface on one side of the body, a second end surface on the other side of the body, and an outer rim. The ribbon includes a multilayer composite comprising first and second superposed layers. The first layer comprises at least first and second generally coplanar strips of fluid treatment media arranged along the second layer. The first strip of fluid treatment medium has a first fluid treatment characteristic. The second strip of fluid treatment medium has a second fluid treatment characteristic which is different from the first fluid treatment characteristic.

In accordance with another aspect of the invention, methods for making a fluid treatment element may comprise superposing first and second layers to form a ribbon, including positioning a first strip of a permeable fluid treatment medium generally coplanar with a second strip of a permeable fluid treatment medium to form the first layer. The first strip of fluid treatment medium has a first fluid treatment characteristic and the second strip of fluid treatment medium has a second fluid treatment characteristic which is different from the first fluid treatment characteristic. The methods may further comprise winding the ribbon in a plurality of windings to form a disk-shaped fluid treatment element having first and second axially-facing end surfaces and an outer rim.

In accordance with another aspect of the invention, methods for treating a fluid may comprise directing a fluid generally edgewise through the windings of a first spirally wound strip of a permeable fluid treatment medium having a first fluid treatment characteristic. The methods further comprise subsequently directing the fluid generally edgewise through the windings of a second spirally wound strip of a permeable fluid treatment medium having a second fluid treatment characteristic. The second fluid treatment characteristic is different from the first fluid treatment characteristic.

In accordance with another aspect of the invention, fluid treatment arrangements may comprise a core assembly, at least first and second fluid treatment elements, a space, functional material disposed in the space, and a fluid flow path. The core assembly has an interior and an axis. Each fluid treatment element includes a ribbon which has a permeable fluid treatment medium, and the ribbon is spirally wound in a plurality of windings to define a generally disk-shaped body which has a radial dimension. The disk-shaped body also has a first end surface on one side of the body, a second end surface on the other side of the body, and an outer rim. At least one of the first and second fluid treatment elements has a first fluid treatment characteristic. The space is adjacent to at least one of the first and second fluid treatment elements. The space is isolated from the interior of the core assembly and the exterior of the fluid treatment arrangement. The functional material, which is disposed in the space, has a second fluid treatment characteristic that is different from the first fluid treatment characteristic. The fluid flow path extends in series through the fluid treatment element having the first fluid treatment characteristic and the functional material having the second fluid treatment characteristic to or from the interior of the core assembly.

Embodiments of the invention provide many advantages. For example, by providing fluid treatment elements, media, and/or functional materials having different fluid treatment characteristics, embodiments of the invention are highly versatile and effective. The fluid can be treated in multiple ways by a single fluid treatment arrangement having two, three, four, or even more fluid treatment characteristics. Further, the fluid treatment arrangement can be tailored to optimally treat each of numerous specific fluids by incorporating multiple fluid treatment characteristics which together best treat the specific fluid.

Many specific embodiments are particularly effective. For example, fluid treatment arrangements may function as filters to remove particulates from a fluid and may include a first fluid treatment medium which has a coarser pore structure or removal rating as a first fluid treatment characteristic and a second fluid treatment medium which has a finer pore structure or removal rating as a second fluid treatment characteristic. The fluid treatment medium with the coarser removal rating may be positioned in the flow path through the fluid treatment arrangement upstream from the fluid treatment medium with the finer removal rating. The fluid then flows first through the medium having the coarser removal rating, where the coarser particulates are first removed from the fluid, and thereafter through the medium having the finer removal rating, where the finer particulates are next removed from the fluid. Fluid treatment arrangements having a coarser upstream removal rating as the first fluid treatment characteristic and a finer downstream removal rating as the second fluid treatment characteristic may have a high dirt capacity and/or a long service life.

### BRIEF DESCRIPTION OF THE DRAWINGS

FIG. 1 is a quarter sectioned view of a fluid treatment arrangement.

FIG. 2 is a front view of a fluid treatment element of FIG. 1.

FIG. 3 is an oblique view of a ribbon.

FIG. 4 is a front view of another fluid treatment element.

FIG. 5 is a front view of another fluid treatment element.

FIG. 6 is a front view of another fluid treatment element.

FIG. 7 is a quarter sectioned view of a fluid treatment assembly including a fluid treatment arrangement having a surround.

FIG. 8 is a quarter sectioned view of another fluid treatment arrangement.

FIG. 9 is a sectioned view of a portion of another fluid treatment arrangement.

FIG. 10 is an oblique view of another ribbon.

FIG. 11 is a sectional view of a portion of another fluid treatment arrangement.

### DESCRIPTION OF EMBODIMENTS

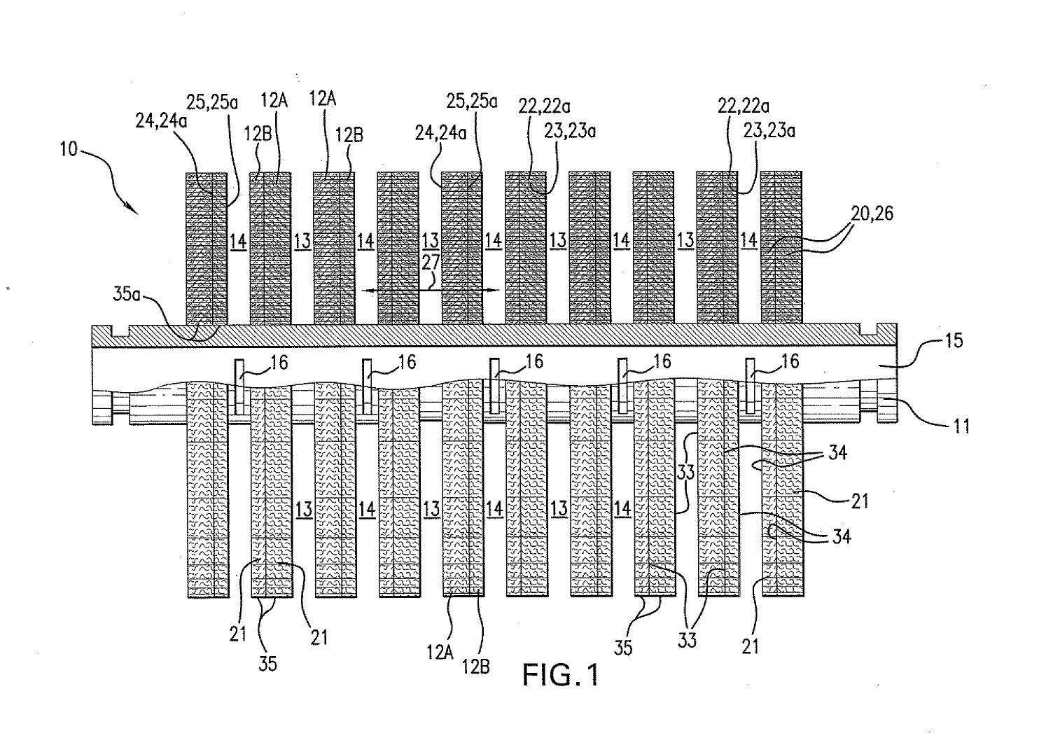

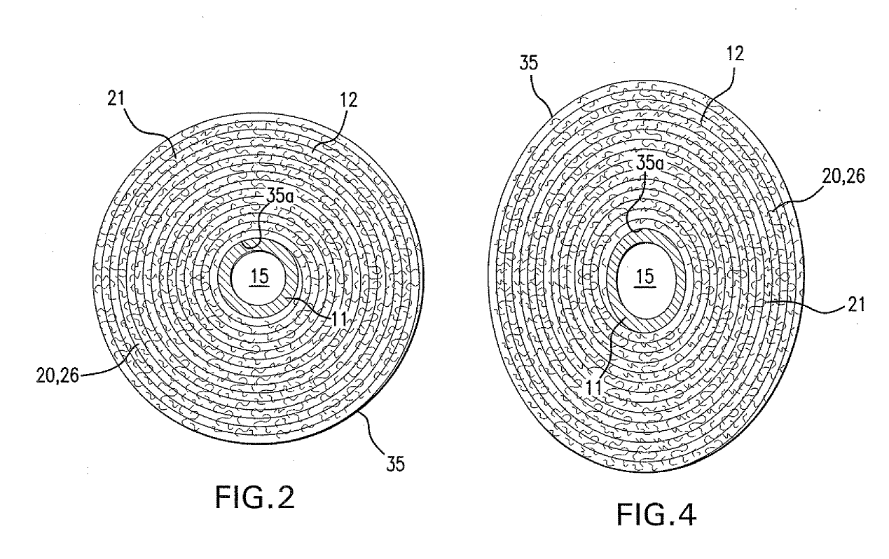

Fluid treatment arrangements embodying one or more aspects of the invention may be configured in a wide variety of ways. One example of a fluid treatment arrangement is shown in FIGS. 1 and 2, but fluid treatment arrangements are not limited to the features illustrated in either of these figures. As shown in FIGS. 1 and 2, a fluid treatment arrangement 10 may comprise a core assembly 11 and a plurality of spirally wound fluid treatment elements positioned along the core assembly 11. The plurality of fluid treatment elements may include a plurality of first fluid treatment elements 12A having a first fluid treatment characteristic and a plurality of second fluid treatment elements 12B having a second fluid treatment characteristic. For example, each fluid treatment element may include at least a first fluid treatment element 12A and a second fluid treatment element 12B, as shown in FIG. 1. The widths and/or radial dimensions of the fluid treatment elements may be similar, e.g., substantially equal, or they may vary along the core assembly 11. Some of the fluid treatment elements may be positioned along the core assembly axially separated from one another to define spaces 13, 14 between adjacent fluid treatment elements. Some of the fluid treatment elements may be axially positioned along the core assembly side-by-side in close proximity to or in contact with one another.

The core assembly 11 may comprise a core, such as a pipe or a tube, having an axis and a generally hollow configuration, including an interior 15. The core assembly 11 may have two open ends or an open end and a closed or blind end. The core assembly 11 may also have openings 16, e.g., axially separated openings, such as slots or other perforations, which allow some of the spaces 14 to fluidly communicate with the interior 15 of the core assembly 11. The spaces 14 that fluidly communicate with the interior 15 of the core assembly 11 may be fluidly isolated in a variety of ways from the exterior of the fluid treatment elements, e.g., the region radially beyond the fluid treatment elements. Other spaces 13 may be fluidly isolated from the interior 15 of the core assembly 11, for example, by a solid wall portion of the core assembly 11 which has no openings and which extends across and blocks the inner end of the space, and these spaces 13 may fluidly communicate with the exterior of the fluid treatment elements. Still other spaces may be isolated from both the interior of the core and the exterior of the fluid treatment elements.

Fluid may be directed generally inwardly or outwardly along a fluid flow path through a first fluid treatment element 12A and a second fluid treatment element 12B between the exterior of the fluid treatment arrangement 10, e.g., the region radially beyond the fluid treatment arrangement, and the interior 15 of the core assembly 11. For example, for many embodiments, including the embodiment illustrated in FIG. 1, a feed fluid may be directed along a fluid flow path from the exterior of the fluid treatment arrangement 10 generally radially inwardly into feed spaces 13 which fluidly communicate with the exterior of the fluid treatment arrangement but are isolated from the interior 15 of the core assembly 11. From the feed spaces 13, the fluid may flow generally axially along the fluid flow path through the first and second fluid treatment elements 12A, 12B of adjacent fluid treatment elements into permeate spaces 14 which are fluidly isolated from the exterior of the fluid treatment elements 12 but which fluidly communicate with the interior 15 of the core assembly 11 via the openings 16 in the core assembly 11. As the fluid flows through the first and second fluid treatment elements 12A, 12B, the fluid may be treated in different ways according to the different fluid treatment characteristics of the elements 12A, 12B. From the permeate spaces 14, the fluid may flow along the fluid flow path generally radially inwardly into and axially along the interior 15 of the core assembly 11.

Alternatively, the feed fluid may be directed into the interior of the core assembly and radially outwardly along a fluid flow path from the interior of the core assembly through the openings in the core assembly into feed spaces which are fluidly isolated from the exterior of the fluid treatment arrangement. From the feed spaces, the fluid may flow generally axially along the fluid flow path through the first and second fluid treatment elements and into permeate spaces which are fluidly isolated from the interior of fluid treatment arrangement but which fluidly communicate with the exterior of the fluid treatment arrangement. From the permeate spaces, the fluid may flow outwardly along the flow path to the exterior of the fluid treatment arrangement.

In each of these embodiments, the fluid may flow along the fluid flow path through only first and second fluid treatment elements, each having a different fluid treatment characteristic. In other embodiments, the fluid may flow along the flow path between the exterior of the fluid treatment arrangement and the interior of the core assembly through more than two, e.g., three, four, five, or more, fluid treatment elements, and each fluid treatment element may have a different fluid treatment characteristic.

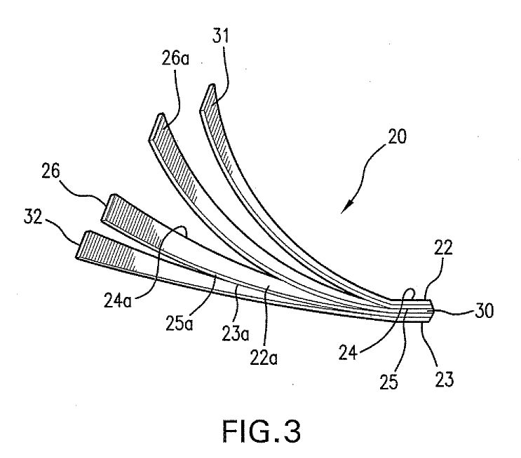

An example of a fluid treatment element 12, which may be a first fluid treatment element or a second fluid treatment element, is shown in FIG. 2, but fluid treatment elements are not limited to the features illustrated in this figure. As shown in FIG. 2, the fluid treatment element 12 may comprise a ribbon 20 which is spirally wound in a plurality of windings to form a generally disk-shaped body 21. Ribbons may be configured in a wide variety of ways. One example of a ribbon is shown in FIG. 3, but ribbons are not limited to the features illustrated in this figure. As shown in FIG. 3, the ribbon 20 may have a long, narrow configuration with opposite major surfaces 22, 23 and opposite side edges 24, 25. The ribbon 20 includes a strip of a permeable fluid treatment medium 26 which also has opposite major surfaces 22a, 23a and opposite side edges 24a, 25a. The ribbon 20 including the porous fluid treatment medium may be permeable but unperforated, i.e., free of any through holes or through slots which extend between the opposite major surfaces 22, 23; 22a, 23a.

The permeable fluid treatment medium may be formed from any of numerous materials, including, for example, a natural or synthetic polymer, glass, metal, carbon, and/or ceramic. The permeable fluid treatment medium may be formed from any of a variety of structures, including, for example, fibrous structures, such as woven or non-woven fibrous strips; meshes, such as woven, extruded, or expanded mesh strips; permeable membranes, such as supported or unsupported membrane strips; porous foam strips; or porous metals, such as porous sintered fiber metal or powder metal strips.

The permeable fluid treatment medium may have any of a myriad of treatment characteristics. For example, the permeable fluid treatment medium may have, or may be modified to have, any of several fluid treatment characteristics including, without limitation, a positive or negative electrical charge; a liquiphobic or liquiphilic surface characteristic, including, for example, hydrophobic or hydrophilic or oleophobic or oleophilic surface characteristic; attached functional groups, such as ligands or any other reactive moiety, that can chemically bind to substances in the fluid; or incorporated functional materials that may chemically or physically bind to, react with, catalyze, deliver, or otherwise affect substances within the fluid and/or the fluid itself, including, without limitation, sorbents, reactants, and catalysts, and chromatography media of all types. More specifically, the functional material may include activated carbon, silica, zeolite, molecular sieves, clay, alumina, sodium bicarbonate, ion exchange resins, catalytic agents, metal oxides, oxidizing agents, reducing agents, buffering agents, biocidal agents, fungicidal agents, viricidal agents, air freshening agents, and perfuming agents. The functional material may be incorporated in the fluid treatment medium, e.g., bonded to, coated on, immobilized in, and/or formed as the fluid treatment medium. For some embodiments, the functional material may be in the form of particles or fibers immobilized in the fluid treatment medium. Further, a fluid treatment characteristic of the permeable fluid treatment medium may include any of a wide range of removal ratings or pore structures, including, for example, from ultraporous or nanoporous or finer to microporous or coarser. For example, the fluid treatment characteristic may include a removal rating in the submicron range or finer, e.g., up to about 0.02 μm or coarser or up to about 0.1 μm or coarser, or in the micron range or coarser, e.g., up to about 1 μm or coarser, or about 5 μm or coarser, or about 10 μm or coarser, or about 50 μm or coarser, or about 75 μm or coarser, or about 100 μm or coarser, or about 200 μm or coarser, or about 300 μm or coarser, or about 500 μm or coarser, or about 1000 μm or coarser. For some embodiments, the permeable fluid treatment medium may comprise a filter medium of nonwoven glass or polymeric fibers and the fluid treatment characteristic of the permeable fluid treatment medium may comprise a removal rating of about 0.02 μm or coarser.

The ribbon, including the strip of permeable fluid treatment medium, may have a variety of lengths, thicknesses, and widths. For many embodiments, the ribbon may be continuous and extend the full length required to provide a sufficient number of windings to form a fluid treatment element having any desired radial dimension. For other embodiments, shorter segments of the ribbon may be connected end-to-end to extend the full length. Further, for many embodiments, the ribbon may be generally straight along the length of the strip. However, the ribbon may be curved. For example, the ribbon may have a cyclical, e.g., sinusoidal or sawtooth, pattern which extends along the length of the strip.

The thickness of the ribbon, including the strip of permeable fluid treatment medium, i.e., the distance through the ribbon from one major surface to the opposite major surface, may vary from one ribbon to another and/or from one fluid treatment element to another, depending, for example, on the structure of the porous fluid treatment medium. The thickness may be in the range from about two thousandths of an inch or less, for example, for a thin permeable polymeric membrane, to about 250 thousandths of an inch or more, for example, for a lofty fibrous material or a porous foam. Although the thickness may be nonuniform along the length of a ribbon, for many embodiments the thickness is uniform along the length of the ribbon.

The width of the ribbon, including the width of the strip of permeable fluid treatment medium, i.e., the distance through the ribbon from one side edge to the opposite side edge, may also vary from one ribbon to another and/or from one fluid treatment element to another. As fluid flows through the fluid treatment element 12, fluid may pass edgewise through the ribbon 20 and the strip of permeable fluid treatment medium 26 from one side edge 24, 25 to the opposite side edge 25, 24. Consequently, the width of the ribbon may affect the pressure drop and the degree of treatment that the fluid undergoes. For example, the width of the ribbon may affect the filtration efficiency. For many embodiments, the width may be in the range from about one-sixteenth of an inch or less to about 1 inch or 2 inches or 3 inches or more. For example, the width may be in the range from about 2 inches or less, e.g., 1 inch or less, to about one-sixteenth inch or more, including the range from about one-eighth inch or more to about one-half inch or less. Further, the width may be uniform along the length of the ribbon, providing a more uniform treatment of the fluid as it flows through the fluid treatment element. Alternatively, the width of the ribbon may be nonuniform along the length of the strip. For example, the width of the ribbon may vary along the length over a shorter distance, e.g., providing a ribbon with one or two pinked edges, or over a longer distance, e.g., providing a fluid treatment element which tapers to a narrow rim or flares to a wide rim, for example. Ribbons having pinked edges, as well as fringed or frizzed edges, are disclosed, for example, in U.S. Provisional Application No. 60/907,065 entitled Fluid Treatment Elements and Fluid Treatment Arrangements with Fluid Treatment Elements Having Uneven Surfaces and Methods for Making and Using Them, which lists Thomas Welch, Jr., Stephen Geibel, and Tanweer ul Haq as an inventor and which was filed on Mar. 19, 2007, and the PCT International Application which claims priority based on this Provisional Application, both of which are incorporated by reference to support these and other features.

The ribbon 20 may include the strip of permeable fluid treatment medium 26 as the sole component of the ribbon, and the major surfaces of the fluid treatment medium may be in contact along adjacent windings. Alternatively, the ribbon may include multiple components. For example, the ribbon may include the permeable fluid treatment medium as one layer of a multilayer composite 30 with multiple layers arranged on top of one another, as shown in FIG. 3. Various additional layers may be included, such as additional layers of permeable fluid treatment media 26a. The fluid treatment media 26, 26a may be identical to, or different from, one another. For example, the permeable fluid treatment medium layers 26, 26a may have the same fluid treatment characteristics or different fluid treatment characteristics, providing a fluid treatment element with fluid treatment media 26, 26a having different fluid treatment characteristic in parallel with one another. Another additional layer may be a strengthening strip 31 that enhances the structural integrity of the ribbon. The ribbon may be in tension as it is wound in multiple windings to form the fluid treatment element, and the strip of permeable fluid treatment medium may not have sufficient strength to withstand the tension. Consequently, a strengthening strip 31 that can withstand the tension, such as a strip of a polymeric film, may be layered with the fluid treatment medium. Another additional layer may be a bonding strip 32 for bonding adjacent surfaces of adjacent windings of the ribbon. While the multiple layers of the composite ribbon may not all have of the same width or be in register, for many embodiments, the multiple layers all have substantially the same width and the side edges are in register, as shown in FIG. 3. The ends of the layers may be in register or may be staggered. For many embodiments, the thickness of the additional layers, other than any additional fluid treatment medium layers, may be less than the thickness of the fluid treatment medium layers to increase the relative volume of the fluid treatment medium within the fluid treatment element. To reduce the amount of fluid that may bypass the fluid treatment medium as it flows through the fluid treatment element, the resistance to fluid flow edgewise through the additional layers may be at least substantially equal to or greater than the resistance to fluid flow edgewise through the fluid treatment medium layers. For some embodiments, the permeability edgewise through the additional layers may be at most substantially equal to or less than the permeability edgewise through the fluid treatment medium layers, and/or the removal rating edgewise through the additional layers may be substantially equal to or finer than the removal rating edgewise through the fluid treatment medium layers. For some embodiments, some or all of the layers of the composite ribbon, other than the fluid treatment medium layers, may be impermeable. Alternatively, the resistance to fluid flow edgewise through the additional layers may be less than the resistance to fluid flow edgewise through the fluid treatment medium layer. For some embodiments, the permeability edgewise through the additional layers may be greater than the permeability edgewise through the fluid treatment medium layers, and/or the removal rating edgewise through the additional layers may be coarser than the removal rating edgewise through the fluid treatment medium layers.

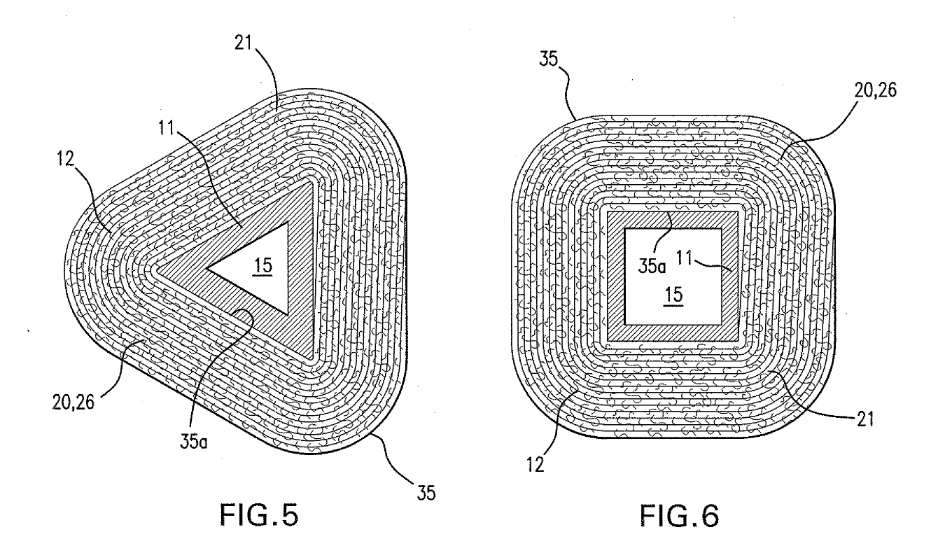

A fluid treatment element 12 formed by spirally winding the ribbon 20 in a plurality of windings may have any of numerous irregular or regular geometrical forms. For example, the spirally wound disk-shaped body 21, as well as the core assembly 11, of the fluid treatment element 12 may have a generally circular form, as shown in FIG. 2, or a generally oval, triangular, or rectangular form, as shown in FIGS. 4, 5, and 6, respectively. The radial dimension of a fluid treatment element 12, i.e., the dimension generally perpendicular to the axis of the core assembly 11, for example, from the innermost winding to the outermost winding, may vary, for example, in accordance with the number of windings and the thickness of the ribbon. For example, the radial dimension may be in the range from up to about ¼ inch or less or about ⅛ inch or less to up to about 1 inch or up to about 2 inches or up to about 6 inches or up to about 10 inches or about 25 inches or more. The volume of a fluid treatment element 12 may vary, for example, in accordance with the width of the ribbon and the radial dimension of the disk-shaped body. For some embodiments all of the fluid treatment elements of a fluid treatment arrangement may have the same volume. For some embodiments the fluid treatment elements of a fluid treatment arrangement may have different volumes. For example, each first fluid treatment element 12A may have a volume different from each second fluid treatment element 12B.

As shown in FIG. 1, each disk-shaped body 21 may have an end surface comprising an inflow or feed surface 33 which faces in one axial direction, and an end surface comprising an outflow or permeate surface 34 which faces in the opposite axial direction, an outer rim 35 along the exterior of the fluid treatment element 12, and an inner rim 35a. Each feed surface 33 may comprise the plurality of windings of one side edge, e.g., the feed side edge 24, of the ribbon 20, including the feed side edge 24a of the permeable fluid treatment medium strip 26. Each permeate surface 34 may comprise the plurality of windings of the other outer side edge, e.g., the permeate side edge 25 of the ribbon 20, including the permeate side edge 25a of the permeable fluid treatment medium strip 26. A fluid pathway 27 extends edgewise between the side edges 24a, 25a through the porous fluid treatment strip 26 from one end surface to the other end surface of each fluid treatment element 12A, 12B. Either or both end surfaces may be an even surface or may be an uneven surface, for example, as disclosed in previously referenced U.S. Provisional Application No. 60/907,065 entitled Fluid Treatment Elements and Fluid Treatment Arrangements with Fluid Treatment Elements Having Uneven Surfaces and Methods for Making and Using Them, and the PCT International Application which claims priority based on this Provisional Application.

The fluid treatment elements may be positioned along the core assembly 11 with adjacent elements spaced from one another or in close proximity to, e.g., contacting, one another along an interface. Further, adjacent fluid treatment elements may be structurally separate from one another. For many embodiments, the feed surfaces 33 of some adjacent fluid treatment elements 12A may face one another and define a feed space 13 between them, and the permeate surfaces 34 of some adjacent elements 12B may face one another and define a permeate space 14 between them. In the embodiment shown in FIG. 1, the permeate spaces 14 may fluidly communicate with the interior 15 of the core assembly 11 via openings 16 in the core assembly 11, and the feed spaces 13 may be fluidly isolated from the interior of the core assembly 11 by a solid wall portion of the core assembly. The distance between adjacent fluid treatment elements may define the width of each space 13, 14, and the widths of the spaces 13, 14 may be uniform or non-uniform. For example, the distances between adjacent feed surfaces 33 and the widths of the feed spaces 13, as well as the distances between adjacent permeate surfaces 34 and the widths of the permeate spaces 14, may be substantially equal to, or different from, one another. Further, the distances between adjacent feed surfaces 33 and the widths of the feed spaces 13 may be substantially equal to, or different from, the distances between adjacent permeate surfaces 34 and the widths of the permeate spaces 14.

The spaces 13, 14 may extend between adjacent fluid treatment elements 12 along at least about 85%, or at least about 90%, or at least about 95%, or about 100% of the radial dimension of the fluid treatment elements 12. For example, the spaces 13, 14 may extend at least about 85%, or at least about 90%, or at least about 95%, or about 100% of the distance from the core assembly to the outer rims 35 at the exterior of the elements. Further, many or all of the spaces 13, 14 may be substantially free of structure, for example, as disclosed in U.S. Provisional Application No. 60/907,068 entitled Fluid Treatment Elements and Fluid Treatment Arrangements with Spaces Between Fluid Treatment Elements and Methods for Making and Using Them, which listed Thomas Welch, Jr., Tanweer ul Hag, and Joseph Verschneider as an inventor and which was filed on Mar. 19, 2007, and the PCT International Application which claims priority based on this Provisional Application, both of which are incorporated by reference to support these and other features. Alternatively, some or all of the spaces may include, for example, may be occupied by, any of a variety of structures, including structures which may serve as spacers and/or supports. These structures may include rigid or flexible plates or grids that may have channels, ribs and/or openings to guide fluid through the spaces. Alternatively, these structures may include one or more layers of mesh or a mass of coarse fibers through which fluid may flow into or out of the spaces. As yet another alternative, these structures may include one or more posts that extend within the spaces, for example, as disclosed in United States Provisional Application No. 60/907,078 entitled Fluid Treatment Elements and Fluid Treatment Arrangements with Posts and/or Bands Between Fluid Treatment Elements and Methods for Making Them, which listed Thomas Welch, Jr., Tanweer ul Haq, and Joseph Verschneider as an inventor and which was filed on Mar. 19, 2007, and the PCT International Application which claims priority based on this Provisional Application, both of which are incorporated by reference to support these and other features.

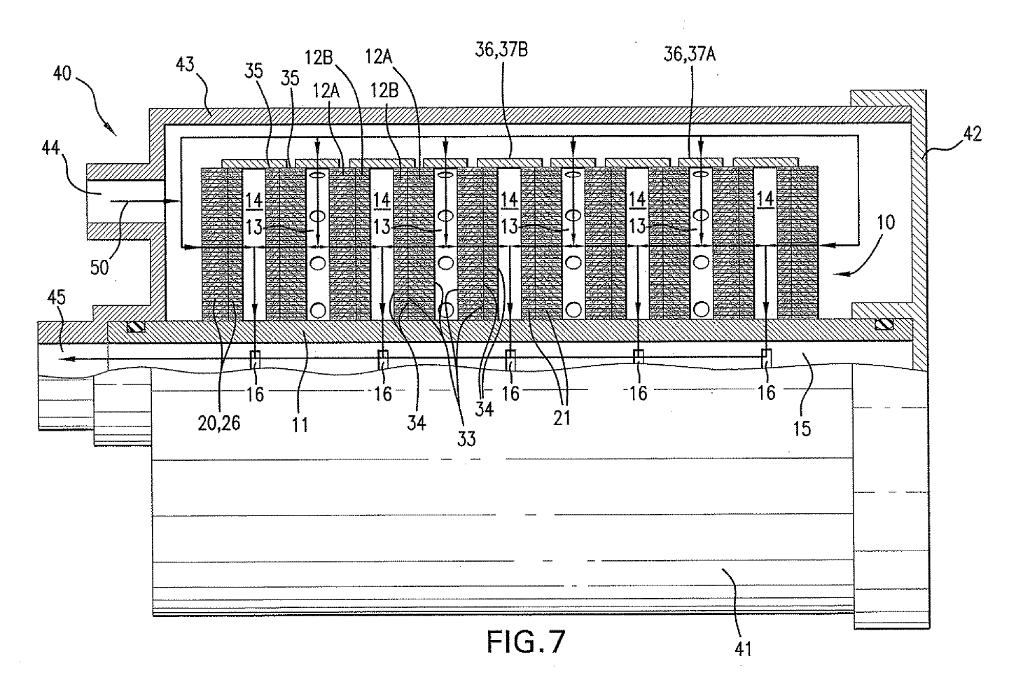

The fluid treatment arrangement may further include additional components, including, for example, a surround associated with the spaces between spaced fluid treatment elements and/or the interfaces between proximal or contacting fluid treatment elements to fluidly isolate one or more of the spaces and/or interfaces, for example, from the exterior of the fluid treatment elements. The surround may be configured in a wide variety of ways, including, for example, as one or more components separate from but associated with the fluid treatment elements. One of many different examples of a surround 36 is shown in FIG. 7. The fluid treatment elements 12A, 12B and the core assembly 11 shown in FIG. 7 may be identical to those previously described, but neither the surround, the fluid treatment elements, nor the core assembly are limited to the features shown in FIG. 7. The illustrated surround 36 comprises a plurality of axially spaced bands 37A encircling the feed spaces 13, bridging the outer rims 35 of the adjacent fluid treatment elements 12A, and having openings that fluidly communicate between the feed spaces 13 and the exterior of the fluid treatment elements 12A. For many embodiments, the bands 37A may span the feed spaces 13 but may be arranged to leave at least a portion of the outer rims 35 of adjacent first fluid treatment elements 12A exposed. For other embodiments the bands may span the spaces and completely cover the outer rims of adjacent first fluid treatment elements or may span the spaces but not extend along the outer rims of adjacent first fluid treatment elements. The surround 36 may further comprise a plurality of axially spaced bands 37B encircling the permeate spaces 14 and bridging the outer rims 35 of the second fluid treatment elements 12B adjacent to each permeate space 14. For many embodiments, the fluid treatment elements 12A adjacent to each feed space 13 may have a first fluid treatment characteristic, while the fluid treatment elements 12B adjacent to each permeate space 14 may have a second different fluid treatment characteristic, or vice versa. To prevent the fluid from bypassing the fluid treatment element 12A having the first fluid treatment characteristic, the surround may extend completely across the outer rims 35 of the fluid treatment element 12B having the second fluid treatment characteristic and completely across any space or interface between the fluid treatment element 12B having the second fluid treatment characteristic and the fluid treatment element 12A having the first fluid treatment characteristic. For example, as shown in FIG. 7, the bands 37B encircling the permeate spaces 14 may extend axially a distance which completely covers the outer rims 35 of the adjacent second fluid treatment elements 12B and the radially outer end of the interface between the second and first fluid treatment elements 12B, 12A.

Alternatively, the surround may have any configuration that fluidly blocks the outer ends of at least some of the spaces, e.g., the permeate spaces, the interfaces, and the outer rims of the second fluid treatment elements and allows fluid communication with other spaces, e.g., the feed spaces. For example, the surround may comprise a sleeve that encircles all of the spaces, interfaces, and the fluid treatment elements, or a helical wrap that is wrapped around all the spaces, the interfaces, and the outer rims of the second fluid treatment elements and the fluid treatment elements, fluidly blocking the outer ends of some of the spaces and having openings that allow fluid communication at the outer ends of other spaces, e.g., fluid communication between the outer rims and the exterior of the fluid treatment elements and other spaces.

The surround may be sealed to the fluid treatment elements in a variety of ways. For many embodiments, the surround 36 may be impermeable and may be bonded to the disk-shaped bodies 21 of the fluid treatment elements 12. For example, the bands 37 may comprise impermeable strips, e.g., impermeable polymeric strips, and may be adhesively bonded, solvent bonded, or heat bonded to the outer rims 35 of the fluid treatment elements 12. Alternatively, the bands may comprise a settable material such as a hot-melt adhesive, a polyurethane, or an epoxy, for example, as disclosed in the previously referenced U.S. Provisional Application No. 60/907,078 entitled Fluid Treatment Elements and Fluid Treatment Arrangements with Posts and/or Bands Between Fluid Treatment Elements and Methods for Making Them and the PCT International Application which claims priority based on this Provisional Application.

Fluid treatment arrangements may be made in any of several different ways. According to one general example, a method for making a fluid treatment arrangement may comprise positioning at least first and second spirally wound, disk-shaped, fluid treatment elements having different fluid treatment characteristics along a hollow core assembly. The first and second fluid treatment elements may be arranged serially in a fluid flow path which extends generally edgewise through the windings of the first and second fluid treatment elements to or from the interior of the core assembly.

The fluid treatment elements may be positioned along the core assembly in a variety of ways. For example, at least two and as many as at least 10 or more, or at least 25 or more, or at least 50 or more or at least 100 or more ribbons may be spirally wound in a plurality of windings around the core assembly to form fluid treatment elements at different axial locations along the core assembly. Some of the ribbons may include a fluid treatment medium having a first fluid treatment characteristic and may be spirally wound to form one or more first fluid treatment elements, and some of the ribbons may include a fluid treatment medium having a second fluid treatment characteristic and may be spirally wound to form one or more second fluid treatment elements. All of the fluid treatment elements may be separated by spaces, or some adjacent fluid treatment elements may be in close proximity, e.g., in contact, side-by-side, while other fluid treatment elements may be spaced from adjacent fluid treatment elements. For example, the ribbons may be spirally wound to position first and second fluid treatment elements 12A, 12B having disk-shaped bodies 21 in proximal pairs side-by-side, e.g., in contact. In the embodiments of FIGS. 1 and 7, the outflow or permeate surface 34 of a first fluid treatment element 12A may closely face and/or contact the inflow or feed surface 33 of a second fluid treatment arrangement 12B. Further, the ribbons may be spirally wound to position adjacent first fluid treatment elements 12A spaced from one another, for example, defining feed spaces 13 between them, and adjacent second fluid treatment elements 12B spaced from one another, for example, defining permeate spaces 14 between them.

The ribbons may be wound around the core assembly one at a time, several at a time, or all at the same time, e.g., either sequentially or simultaneously. The inner end region of the ribbon, e.g., the region defining the first one, two, or three windings, may be sufficiently sealed against the core assembly to prevent bypass of the fluid treatment element. For example, the inner end region may be fixed to the core assembly by heat bonding, adhesively bonding, or solvent bonding the inner end region to the core assembly. Alternatively, the inner end region may not be bonded to the core assembly but may, for example, be compressively fit against the core assembly by tightly winding the initial windings around the core assembly. Further, the inner end region may have a tapered thickness or may be sufficiently tightly wound that no step is formed at the transition between the end of the first winding and the beginning of the second winding.

Each ribbon may be spirally wound in a plurality of windings under tension to form a fluid treatment element of any desired radial dimension. The tension may be constant or may vary with increasing radius of the fluid treatment element, and the tension may be empirically selected based on many factors. For example, a maximum tension at which the ribbon detrimentally elongates, e.g., the tension at which the fluid treatment medium unduely stretches or begins pulling apart, may be determined. The ribbon may then be spirally wound using a tension less than the maximum tension, for example, no greater than about 80% or no greater than about 65% or no greater than about 50% of this maximum tension. Further, the ribbon may be spirally wound using a tension which provides similar compression, e.g., substantially uniform compression, of the fluid treatment medium from one winding to the next along most or all of the radial dimension of the fluid treatment element. By providing similar compression from one winding to the next, the fluid treatment element may more evenly treat the fluid flowing edgewise through the plurality of windings of the fluid treatment medium. For example, if the fluid treatment medium comprises a filter medium, the fluid treatment element may be more uniformly loaded along the radial dimension of the element, increasing the dirt capacity and/or the service life of the element. In addition, the ribbon may be spirally wound with sufficient tension to inhibit or prevent the flow of fluid laterally between adjacent surfaces of adjacent windings and adjacent layers of the ribbon. For example, the ribbon may be spirally wound with sufficient tension that substantially no fluid passes laterally between the adjacent surfaces and adjacent layers or with sufficient tension that any fluid pathway laterally between the adjacent surfaces and adjacent layers of the ribbon has a permeability and/or a removal rating which is not substantially greater or coarser than the permeability and/or removal rating of the fluid pathway edgewise through the fluid treatment medium. The ribbon may also be wound with sufficient tension to form a substantially self-supporting fluid treatment element having a stable, firm disk-shaped body. For example, the ribbon may be wound with sufficient tension to hold adjacent windings and adjacent layers against each other tightly enough to prevent lateral slippage and/or radial separation of the adjacent windings and adjacent layers at the differential pressures encountered by the fluid treatment element.

The width of a first ribbon and/or the radial dimension of the fluid treatment element formed by spirally winding the first ribbon may differ from the width of a second ribbon and/or the radial dimension of the fluid treatment element formed by spirally winding the second ribbon in order to vary the volume of the fluid treatment elements. For example, as shown in FIGS. 1 and 7, the radial dimension of the first and second fluid treatment elements 12A, 12B may be substantially equal, facilitating installation of the surround 36. However, the ribbon of each first fluid treatment element 12A having the first fluid treatment characteristic may be narrower than the ribbon of each second fluid treatment element 12B having the second fluid treatment characteristic, or vice versa. One of the first and second fluid treatment elements, e.g., the first fluid treatment element 12A, may thus be formed with a different volume, e.g., a smaller volume, than the other of the first and second fluid treatment elements, e.g., the second fluid treatment element 12B.

After each ribbon has been spirally wound to a desired radial dimension, the outer end region of the ribbon may be held in place in any of numerous ways. For example, the outer end region may be bonded to the adjacent winding for example, by heat bonding, adhesive bonding, or solvent bonding. Alternatively or additionally, the outer end region of the ribbon may be staked to other windings. For example, a hot, metal pin may be inserted generally radially through the outer end region of the ribbon and the outer windings, melting the portions of the ribbon that contact the pin. When the pin is withdrawn, the molten portions solidify with one another, forming a generally radial stake which holds the outer end region, including any multiple layers of the ribbon, and the outer windings in place. Alternatively or additionally, a hollow needle, which may or may not be hot, may be inserted generally radially through the outer end region and the outer windings or in the space between adjacent windings. A liquid settable bonding composition or material, including, for example, a polyurethane, an epoxy, or a hot melt adhesive, may be injected into the windings as the needle is withdrawn, forming a generally radial stake which holds the outer end region and the windings in place. As yet another alternative, a stake, for example, in the form of a weld bead or a bead of settable bonding material, may be drawn along one or both side edges of the outer end region of the ribbon and the outer windings.

The stability of a spirally wound fluid treatment element may be further enhanced by staking much or all of the disk-shaped body. For example, generally radially extending stakes may be formed through most or substantially all of the windings and/or at various angularly-spaced positions around the disk-shaped body. Similarly, stakes may be applied along one or both end surfaces of the fluid treatment element and/or at various angularly-spaced positions around each surface, including the surfaces at the interface between the first and second fluid treatment elements. Each stake may extend mostly or completely through or along the fluid treatment element, e.g., to the core assembly, fixing the fluid treatment to the core assembly.

The stability of a spirally wound fluid treatment element may also be enhanced by bonding adjacent windings, and/or adjacent layers of the ribbon, to one another continuously or intermittently along the length of the spirally wound ribbon. Adjacent windings and/or layers may be bonded in a variety of ways. For example, the ribbon may include a bonding layer, as previously described. The bonding layer may comprise an adhesive which bonds adjacent windings and/or layers as the ribbon is spirally wound. Alternatively, the bonding layer may be activated by applying a solvent or heat to the fluid treatment element after the element is formed. As yet another alternative, a hot melt adhesive or a heat bond may be applied, for example, intermittently, between adjacent windings and/or layers as the ribbon is spirally wound.

The fluid treatment elements may be positioned along the core assembly with spaces between some of the elements. Some of the spaces, e.g., the feed spaces 13, may be positioned in fluid communication with the exterior of the fluid treatment arrangement and some of the spaces, e.g., the permeate spaces 14, may be fluidly isolated from the exterior of the fluid treatment arrangement. Further, some of the spaces e.g., the permeate spaces 14, may be positioned in fluid communication with the openings in the core assembly and other spaces, e.g., the feed spaces 13, may be fluidly isolated from the interior of the core assembly. Before, while, or after the fluid treatment elements are positioned along the core assembly, various structures may be arranged along the core assembly in, or at the locations corresponding to, some or all of the spaces between the elements. For example, meshes, fibrous masses, plates, grids, and/or posts may be positioned in some or all of the spaces between the elements.

The surround may be coupled to the fluid treatment elements, the interfaces, and the spaces in a variety of ways. For example, a surround comprising a plurality of bands may be positioned around the interfaces and spaces, and the bands may be sealed to the adjacent fluid treatment elements, e.g., at the outer rims. Alternatively, a surround comprising a sheet spanning the fluid treatment elements, the interfaces, and spaces may be wrapped circumferentially around the elements, the interfaces, and spaces and formed into a sleeve, or a surround comprising a preformed sleeve may be slid axially over the fluid treatment elements, the interfaces, and spaces. The sleeve may be sealed to the fluid treatment elements, e.g., at the outer rims. Openings may be formed in the sleeve which allows the spaces that are fluidly isolated from the core assembly to fluidly communicate with the exterior of the fluid treatment elements. As yet another alternative, a surround comprising a wide strip may be helically wound around the fluid treatment elements and the spaces with adjacent helical windings overlapping one another. The wrap may be sealed to the fluid treatment elements, and openings may be formed in the wrap which allows the spaces that are fluidly isolated from the core assembly to fluidly communicate with the exterior of the fluid treatment elements.

After the fluid treatment arrangements are formed, they may be contained within a wide variety of housings to provide fluid treatment assemblies. The fluid treatment assembly may comprise a housing containing only a single fluid treatment arrangement or a housing containing multiple fluid treatment arrangements arranged serially or in parallel within the housing. For example, the housing may include one or more tube sheets and multiple fluid treatment arrangements may be associated with the tube sheets. The housing may permanently contain the fluid treatment arrangement, e.g., forming a disposable fluid treatment arrangement, or the housing may removably contain the fluid treatment arrangement, allowing a used fluid treatment arrangement to be replaced by a new fluid treatment arrangement in a reusable housing.

The housing may be formed from any impermeable material, e.g., a metallic material or a polymeric material, which is compatible with the process parameters, e.g., the pressure and temperature and the chemical composition of the fluid. The housing may have two or more principle ports, e.g., a process or feed fluid inlet port and a filtrate or permeate outlet port. The housing may define a fluid flow path between the ports, and the fluid treatment arrangement may be positioned in the housing with the first and second fluid treatment elements disposed in series in the fluid flow path. The ports may be situated on the housing in any of numerous configurations, including an in-line configuration, a T-type configuration, or an L-type configuration, and the ports may comprise any of a wide variety of fittings. The housing may further include additional ports, including, for example, a retentate or concentrate outlet port and one or more ports associated with draining, venting, or cleaning, e.g., backwashing.

One of many examples of a fluid treatment assembly 40 and a housing 41 containing at least one fluid treatment arrangement 10 is shown in FIG. 7, but fluid treatment assemblies and housings are not limited to the features illustrated in FIG. 7. The housing 41 may include a cover 42 and a shell 43. The cover 42 may be permanently or removably mounted to the shell 43 at one end of the shell 43. The other end of the shell 43 may have a feed inlet port 44, e.g., an off center feed inlet port 44, and a permeate outlet port 45, e.g., a central permeate outlet port 45. The illustrated embodiment of the fluid treatment assembly 40 has only two ports 44, 45, and they are located on one end of the housing 41. Other embodiments may include more than two ports, and the ports may be located anywhere along the housing, e.g., at both ends and/or in the side of the housing.

The fluid treatment arrangement 10 may be sealed within the housing 41 across a fluid flow path 50 between the feed inlet port 44 and the permeate outlet port 45 with the shell 43 surrounding the fluid treatment elements 12A, 12B. A portion of the fluid flow path 50 between the inlet port 44 and the outlet port 45 includes the fluid flow pathways which extend in series generally edgewise through the fluid treatment medium of the first fluid treatment element 12A having the first fluid treatment characteristic and the fluid treatment medium of the second fluid treatment element 12B having the second fluid treatment characteristic. The fluid treatment arrangement 10 may be sealed in the housing 41 in any of numerous ways. For example, one end of the hollow core assembly 11 may be blindly sealed against the cover 42. The opposite end of the hollow core assembly 11 may be open and sealed to the shell 43 at the permeate outlet port 45, allowing fluid communication between the interior 15 of the core assembly 11 and the permeate outlet port 45. For many embodiments, none of the fluid treatment elements may be sealed to the housing 41. For example, only the core assembly 11 may be sealed to the housing 41, minimizing seals and providing a highly reliable fluid treatment assembly.

Fluids may be treated in any of numerous ways by fluid treatment assemblies, arrangements, and elements embodying the invention. In one mode of operation, a feed fluid may be treated by directing the fluid generally edgewise through the windings of a first spirally wound strip of a permeable fluid treatment medium and then directing the fluid generally edgewise through the windings of a second spirally wound strip of a permeable fluid treatment medium. The permeable medium of the first strip has a first fluid treatment characteristic, and the permeable medium of the second strip has a second fluid treatment characteristic which is different from the first fluid treatment characteristic. For example, the feed fluid may be directed through the fluid treatment assembly 40 along the fluid flow path 50, where the fluid maybe treated differently by the fluid treatment elements 12A, 12B in accordance with the different fluid treatment characteristics of the elements. In the illustrated fluid treatment assembly 40, the feed fluid may be directed outside-in through the fluid treatment arrangement 10 from the exterior of the fluid treatment elements 12A, 12B to the interior 15 of the core assembly 11. However, in other embodiments the feed fluid may be directed inside-out through the fluid treatment arrangement from the interior of the core assembly to the exterior of the fluid treatment elements.

In the embodiment of FIG. 7, feed fluid may enter the housing 41 through the feed inlet port 44 and follow the fluid flow path 50 to the permeate outlet port 45. From the feed inlet port 44, the feed fluid may flow generally axially along the housing 41 between the exterior of the fluid treatment elements 12A, 12B and the interior of the shell 43. The feed fluid then flows generally radially inwardly into the feed spaces 13 between the feed surfaces 33 of the first fluid treatment elements 12A and along any structures which may be in the feed spaces. From the feed spaces 13, the feed fluid may flow generally axially through each adjacent first fluid element 12A having the first fluid treatment characteristic and then through an adjacent or nearby second fluid treatment element 12B having the different second fluid treatment characteristic. For example, the feed fluid may flow generally axially into the feed surface 33 of the disk-shaped body 21 of the first fluid treatment element 12A and generally edgewise through the ribbon 20, including the fluid treatment medium 26, of each winding. The fluid may also flow radially from the fluid treatment medium of one winding into and then laterally along the medium of one or more adjacent windings. As the fluid passes through the fluid treatment medium having the first fluid treatment characteristic, the fluid is treated in accordance with the first fluid treatment characteristic. From the fluid treatment medium 26, the fluid may flow out of the first fluid treatment element 12A through the permeate surface 34 of the disk-shaped body 21. From the permeate surface 34 of the first fluid treatment element 12A, the fluid may flow directly into the feed surface 33 of the disk-shaped body 21 of the second fluid treatment element 12B. Alternatively, the fluid may flow through an intervening region, such as an intervening space, before flowing into the feed surface of the second fluid treatment element. From the feed surface 33, the fluid may flow generally edgewise through the ribbon 20, including the fluid treatment medium 26, of each winding. The fluid may also flow radially from the fluid treatment medium of one winding into and then laterally along the medium of one or more adjacent windings. As the fluid passes through the fluid treatment medium having the second fluid treatment characteristic, the fluid is differently treated in accordance with the second fluid treatment characteristic. From the fluid treatment medium 26, the fluid may flow out of the second fluid treatment medium 12B through the permeate surface 34 of the disk-shaped body 21.

The treated fluid emerges from the permeate surfaces 34 of the second fluid treatment elements 12B and flows into the permeate space 14 between the permeate surfaces 34 of adjacent second fluid treatment elements 12B. From the permeate spaces 14, the treated fluid may flow generally radially inwardly through the openings 16 into the interior 15 of the core assembly 11. The treated fluid then flows axially along the interior 15 of the core assembly 11 to and through the permeate outlet port 45 of the housing 41.

As the fluid passes in series through the first and second fluid treatment elements 12A, 12B, it may be treated in any combination of different ways in accordance with the first and second fluid treatment characteristics of the elements. For example, the first fluid treatment characteristic may relate to a coarser removal rating of the fluid treatment medium of the first fluid treatment element, and the fluid may be first treated by removing coarser particulates from the fluid. The second fluid treatment characteristic may relate to a finer removal rating of the fluid treatment medium of the second fluid treatment element, and the fluid may next be differently treated by removing finer particulates from the fluid. As another example, the first fluid treatment characteristic may relate to a removal rating of the fluid treatment medium of the first fluid treatment element, and fluid may be first treated by removing particulates from the fluid. The second fluid treatment characteristic may relate to a binding mechanism such as a sorbent or a reactive moiety in the fluid treatment medium of the second fluid treatment element, and the fluid may next be differently treated by physically or chemically binding one or more substances in the fluid to the second fluid treatment element, thereby removing the substances from the fluid. As yet another example, the first and second fluid treatment characteristics may relate to different binding mechanisms such as different reactive moieties in the fluid treatment media of the first and second fluid treatment elements. The fluid may be first treated by binding a first substance in the fluid to the first fluid treatment element, and the fluid may next be differently treated by binding a second substance in the fluid to the second fluid treatment element, thereby removing both substances from the fluid. For some embodiments, after one or more substances have been bound or otherwise captured in the first and/or second fluid treatment elements, an eluant, such as an organic solvent, water, or an aqueous solution of an acid or base, may be directed through the fluid treatment elements to strip the substance from the elements.

Although a few examples of the different ways a fluid may be treated by passing in series through the first and second fluid treatment elements have been described, there are innumerable combinations of fluid treatment characteristics, and corresponding fluid treatments, that may be employed in fluid treatment elements, arrangements, and assemblies embodying the invention. Further, there are many advantages associated with these fluid treatment elements, arrangements, and assemblies. For example, by providing fluid treatment elements or media having different fluid treatment characteristics, embodiments of the invention are highly versatile and effective. The fluid can be treated in multiple ways by a single fluid treatment arrangement having two, three, four, or more fluid treatment characteristics. Further, a fluid treatment arrangement can be easily tailored to optimally treat each of numerous specific fluids by incorporating multiple fluid treatment characteristics that best treat the specific fluid.

In addition, spirally winding separate ribbons to separately form each of the plurality of fluid treatment elements facilitates manufacturing different configurations of fluid treatment arrangements and elements. The radial dimension of each element may be easily varied by winding more or less of the ribbon around the core assembly; the number of fluid treatment elements provided along the core assembly can be easily varied by winding more or fewer ribbons around the core assembly; the location of the fluid treatment elements along the core assembly can be easily varied by simply adjusting the spacing between the ribbons being wound around the core assembly; and fluid treatment elements with different fluid treatment characteristics may be readily provided by simply winding ribbons having different fluid treatment characteristics. Further, the ribbons may be spirally wound around the core assembly very quickly, speeding manufacture. Using a plurality of separate, narrow ribbons instead of, for example, a single, wide sheet with slots or other throughholes in the sheet may then significantly enhance the flexibility and efficiency of manufacture, allowing fluid treatment arrangements with various numbers of elements and spacings between elements to be made without having to change out sheets of different widths or different throughhole configurations. In addition, if a defect such as a hole or tear in the permeable fluid treatment medium occurs during manufacture, only the defective ribbon may be replaced rather than an entire sheet, allowing for faster and more efficient production.

While various aspects of the invention have been previously described and/or illustrated with respect to several embodiments, the invention is not limited to these embodiments. For instance, one or more features of these embodiments may be eliminated without departing from the scope of the invention. For example, as previously described, the surround 36 may include one or more bands 37A that encircle the feed spaces 13 and have openings that fluidly communicate between the exterior of the fluid treatment elements 12A and the feed spaces 13. These bands 37A may be entirely eliminated without departing from the scope of the invention. The feed spaces may simply open onto the exterior of the fluid treatment elements.

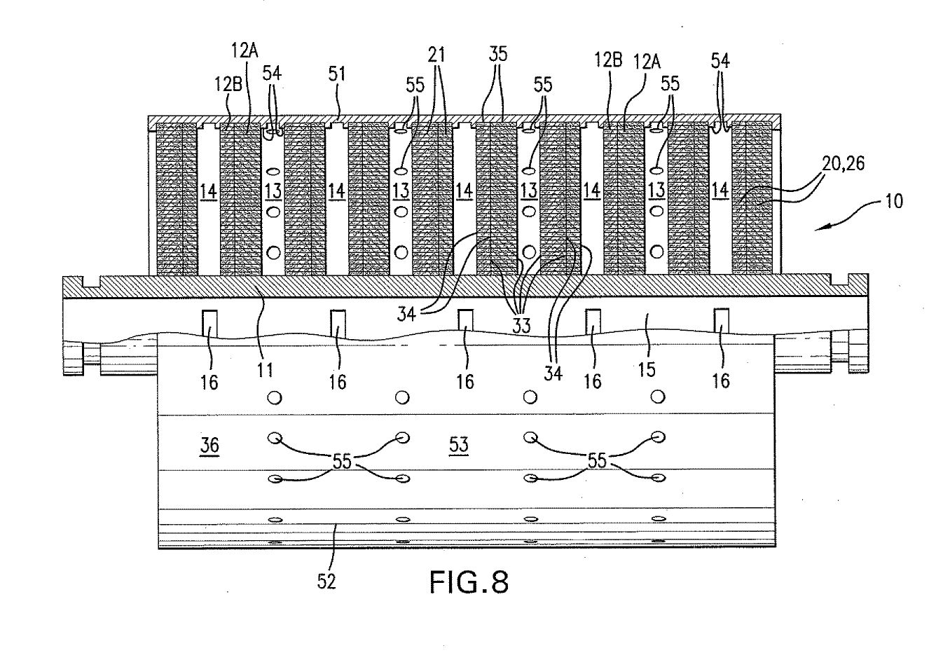

Further, one or more features of an embodiment may be modified, or one or more features of any embodiment may be combined with one or more features of other embodiments, without departing from the scope of the invention. For example, the surround may comprise a more rigid structure to provide additional support at the outer rims of the fluid treatment elements. In one embodiment, the surround 36 may comprise semi-cylindrical sections 51, 52 which may be joined to form a more rigid cage 53, as shown in FIG. 8. The fluid treatment elements 12A, 12B and the core assembly 11 shown in FIG. 8 may be identical to those previously described, but neither the surround, the fluid treatment elements, nor the core assembly are limited to the features shown in FIG. 8. Each fluid treatment element 12A, 12B may comprise a spirally wound ribbon 20 which includes a strip of a fluid treatment medium 26. The sections 51, 52 of the surround 36 may be fitted around the outer rims 35 of the fluid treatment elements 12A, 12B and permanently or removably joined to one another to form the cage 53. The outer rims 35 of the disk shaped bodies 21 of the fluid treatment elements 12A, 12B may be sealed against the cage 53 in a variety of ways. For example, the outer rims 35 may be adhesively bonded or heat bonded to the cage 53. Alternatively or additionally, the outer rims 35 may be sealed against the cage 53 by a tight mechanical fit. For example, a pair of circumferential ribs 54 may extend inwardly a short distance from each section 51, 52 and may be spaced apart a distance equal to or slightly less than the widths of the outer rims 35 of the proximal or contacting fluid treatment element 12A, 12B. The sections 51, 52 may be fitted around the fluid treatment arrangement 10 with the outer rims 35 fitting between a corresponding pair of ribs 54. The cage 53 may include openings 55 that allow some of the spaces, e.g., the feed spaces 13, to fluidly communicate with the exterior of the fluid treatment elements 12A, 12B. The cage 53 may fluidly isolate other spaces, e.g., the permeate spaces 14, from the exterior of the fluid treatment elements 12A, 12B.

As yet another example, first and second fluid treatment elements may be positioned along the core assembly by sliding preformed elements generally axially along the core assembly. For example, a ribbon including a fluid treatment medium having a first fluid treatment characteristic and a ribbon including a fluid treatment medium having a second fluid treatment characteristic may be spirally wound in a plurality of windings to a desired radial dimension around separate central hubs, rather than around the core assembly, to form a fluid treatment element. The preformed first and second fluid treatment elements may then be slid axially, with or without the hubs, along the core assembly to the desired locations and fixed in place.

Further, embodiments having different features may nonetheless be within the scope of the invention. For example, a ribbon including a fluid treatment medium having a first fluid treatment characteristic and a ribbon including a fluid treatment medium having a second fluid treatment characteristic may be spirally wound around separate hubs to form the first and second fluid treatment elements. Each hub may comprise a section of the core assembly, and the hub sections of adjacent elements may be connected to one another to form the hollow core assembly and the fluid treatment arrangement. The hub sections may be mechanically coupled to one another and/or bonded to one another, and some of the hub sections may include openings which allow fluid communication with the interior of the core assembly.

As another example, a first sheet assembly may comprise a sheet of a porous fluid treatment medium having the first fluid treatment characteristic, and the sheet may be the sole component or one layer of a multilayer composite, e.g., similar to the multilayer composite of the ribbon. Similarly, a second sheet assembly may comprise a sheet of a porous fluid treatment medium having the second fluid treatment characteristic, and the sheet may be the sole component or one layer of a multilayer composite. The sheet assemblies may be spirally wound in a plurality of windings to form rolls having desired radial dimensions. Sections having a desired width may then be cut, e.g. sliced from the rolls in a direction perpendicular to the axis of the rolls to form the first and second fluid treatment elements. The first and second fluid treatment elements may then be positioned along a core assembly, e.g., by axially sliding the preformed elements along the core assembly, or the first and second fluid treatment elements may be positioned on hub sections and the hub sections may be connected to one another to form a fluid treatment arrangement including the hollow core assembly.

As yet another example, a fluid treatment arrangement may include multiple sets, e.g., two, three, four or more sets, of fluid treatment elements which are mounted along the core assembly radially displaced from one another, for example, in a manner similar to that disclosed in U.S. Provisional Application No. 60/907,066 entitled Fluid Treatment Arrangements with Sets of Fluid Treatment Elements and Methods for Making and Using Them, which listed Thomas Welch, Jr., Tanweer ul Haq, and Joseph Verschneider as an inventor and which was filed on Mar. 19, 2007, and the PCT International Application which claims priority based on this Provisional Application, both of which are incorporated by reference to support these and other features. Each set may include a plurality of fluid treatment elements, each element including a ribbon which is spirally wound in a plurality of windings to form a generally disk-shaped body having a radial dimension. Each set may include a plurality of first and second fluid treatment elements. Alternatively, one set may include a plurality of first fluid treatment elements and no second fluid treatment elements, while the other set may include a plurality of second fluid treatment elements and no first fluid treatment elements. The outer set of fluid treatment elements may overlie the inner set of fluid treatment elements with the elements of the inner and outer sets radially and/or axially aligned or offset. For example, the elements of the outer set may bridge at least some of the spaces between the elements of the inner set. Further, the size, e.g., the width and radial dimension, and/or the volume of the outer set of fluid treatment elements may be the same as or different from those of the inner set of fluid treatment elements.

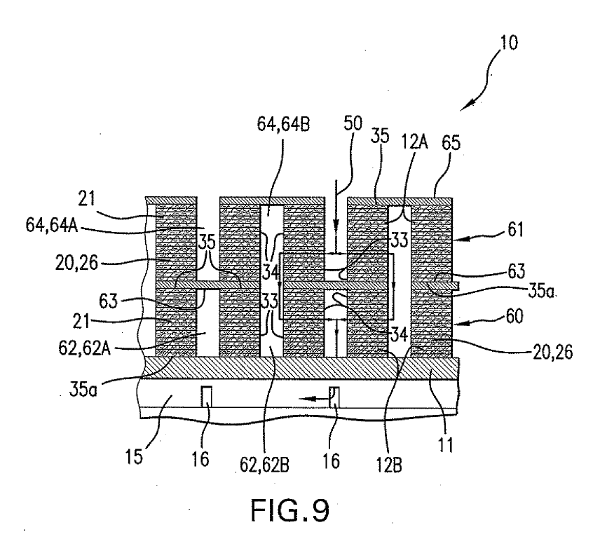

In the embodiment shown in FIG. 9, a fluid treatment arrangement 10 may include at least inner and outer sets 60, 61 of fluid treatment elements mounted along a core assembly 11. For example, the outer set 61 may comprise a plurality of spirally wound first fluid treatment elements 12A having a first fluid treatment characteristic and no second fluid treatment elements having a second fluid treatment characteristic. The inner set 60 may comprise a plurality of spirally wound second fluid treatment elements 12B having the second fluid treatment characteristic and no first fluid treatment elements having the first fluid treatment characteristic. The fluid treatment elements 12A, 12B of each set 60, 61 may comprise a ribbon 20 which includes a strip of a fluid treatment medium 26 and is spirally wound to form a disk-shaped body 21.

The inner set 60 of second fluid treatment elements 12B may be positioned along and immediately circumjacent to the core assembly 11 as previously described with spaces 62 between at least some or all of the adjacent inner second fluid treatment elements 12B. An inner surround comprising, for example, a plurality of inner bands 63, may bridge at least some of the inner spaces 62 between adjacent inner second fluid treatment elements 12B. The features of the core assembly 11, the fluid treatment elements 12B of the inner set 60, the inner spaces 62 and the inner bands 63 may be similar to those previously described. Radially displaced from the inner set 60 of fluid treatment elements 12B, the outer set 61 of first fluid treatment elements 12A may be positioned along the core assembly 11 with spaces 64 between at least some or all of the outer first fluid treatment elements 12A. The outer first fluid treatment elements 12A may be spirally wound around the inner second fluid treatment elements 12B and/or the inner surround, e.g., the inner bands 63. The inner end region of the ribbon of each outer first fluid treatment element 12A may be sealed against the inner second fluid treatment elements 12B or the inner bands 63 as previously described for the inner end region of the ribbon of each fluid treatment element 12 and the core assembly 11 of the embodiment of FIG. 1. The size and/or volume of each outer first fluid treatment element 12A may be the same as or different from the size and/or volume of each inner second fluid treatment element 12B. An outer surround comprising, for example, a plurality of outer bands 65, may bridge at least some of the outer spaces 64 between adjacent outer first fluid treatment elements 12A. The features of the first fluid treatment elements 12A, the outer spaces 64, and the outer bands 65 may be similar to those previously described. The inner spaces 62 and/or outer spaces 64 may be substantially free of structure or may include one or more structural elements as previously described.

The inner and outer sets of fluid treatment elements and the inner and outer surrounds may be arranged to direct fluid in series generally axially through one or more outer fluid treatment elements and generally axially through one or more inner fluid treatment elements as the fluid flows from the exterior of the fluid treatment arrangement to the interior of the core assembly or vice versa. For example, in the embodiment of FIG. 9, some of the outer spaces 64A may be open to the exterior of the fluid treatment arrangement 10 and closed along the inner diameters of the outer first fluid treatment elements 12A by the inner bands 63. Other outer spaces 64B may be isolated from the exterior of the fluid treatment arrangement 10 by the outer bands 65 and open to the inner spaces 62B along the inner diameter of the outer first fluid treatment elements 12A. The inner spaces 62B which open onto the outer spaces 64B may be closed along the inner diameter of the inner spaces 62B by a solid wall of the core assembly 11. The inner spaces 62A which are closed by the inner bands 63 may open into the interior 15 of the core assembly 11 though the openings 16 in the core assembly 11.

Fluid treatment arrangements having multiple, radially displaced sets of fluid treatment elements may be contained within a wide variety of housings to provide fluid treatment assemblies, as previously described for the embodiments of FIGS. 1-9.

In one mode of operation feed fluid may be directed through the fluid treatment arrangement 10 along a fluid flow path 50 within a housing between the exterior of the fluid treatment arrangement 10 and the interior 15 of the core assembly 11. For example, in the embodiment of FIG. 9, feed fluid may be directed generally radially into the open outer spaces 64A, further radial flow being blocked by the inner bands 63. From the open outer spaces 64A the feed fluid may flow generally axially through the outer first fluid treatment elements 12A into the outer spaces 64B that are isolated from the exterior of the fluid treatment arrangement 10 by the outer bands 65. As the fluid flows axially through the outer first fluid treatment elements 12A, the fluid may pass generally edgewise through the ribbon 20, including the fluid treatment medium 26, of each winding and may pass radially from the fluid treatment medium of one winding into and then laterally along the fluid treatment medium of one or more adjacent or nearby windings. As the fluid flows through the fluid treatment medium having the first fluid treatment characteristic, the fluid is treated in accordance with the first fluid treatment characteristic. From the isolated outer spaces 64B, the fluid may flow generally radially into the inner spaces 62B that fluidly communicate with the outer spaces 64B, further radial flow being blocked by the solid wall of the core assembly 11. From these inner spaces 62B, the fluid may flow generally axially through the inner second fluid treatment elements 12B into the inner spaces 62A that are isolated from the outer spaces 64A by the inner bands 63. As fluid flows axially through the inner second fluid treatment elements 12B, the fluid may pass generally edgewise through the ribbon 20, including the fluid treatment medium 26, of each winding and may pass radially from the fluid treatment medium of one winding into and then laterally along the fluid treatment medium of one or more adjacent or nearby windings. As the fluid flows through the fluid treatment medium having the second fluid treatment characteristic, the fluid is next treated in accordance with the second fluid treatment characteristic. From the inner spaces 62A which are isolated from the outer spaces 64A, the fluid may flow generally radially through the openings 16 into the interior 15 of the core assembly 11.

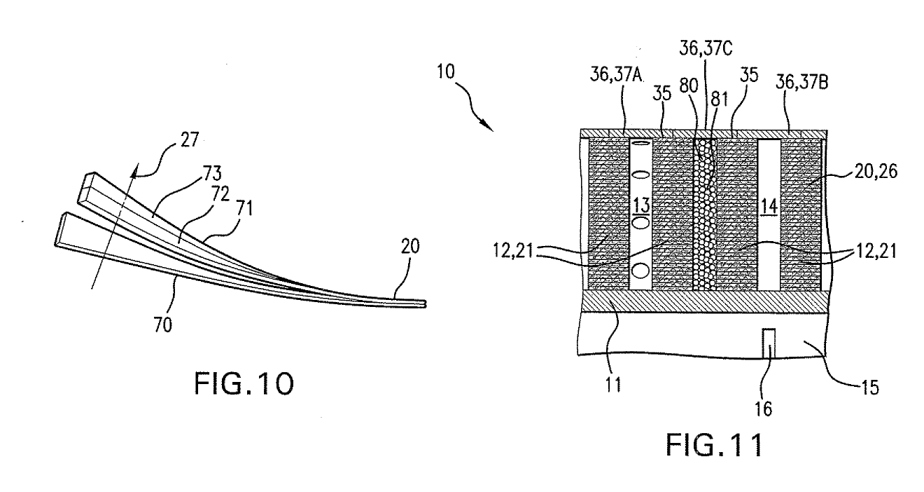

As another example, a single ribbon may include multiple strips of permeable fluid treatment media having different fluid treatment characteristics. For example the ribbon may include a first strip of a permeable fluid treatment medium having a first fluid treatment characteristic and a second strip of a permeable fluid treatment medium having a second fluid treatment characteristic. Each of the multiple strips of media may be similar to any of the permeable fluid treatment media previously described and may include any of the fluid treatment characteristics previously described. The multiple strips may be arranged in series in a single fluid treatment element formed by spirally winding the ribbon in a plurality of windings. For example, as shown in FIG. 10, a ribbon 20 may comprise a multilayer composite including at least a support layer 70 and a fluid treatment layer 71 superposed on one another. The support layer 70 may be impermeable or less permeable than the fluid treatment layer 71 to prevent bypass of the fluid treatment layer 71. The fluid treatment layer 71 may comprise first and second strips 72, 73 of permeable fluid treatment media, the medium of the first strip 72 having a first fluid treatment characteristic and the medium of the second strip 73 having a second fluid treatment characteristic. Each strip may have opposite major surfaces and opposite side edges similar to the fluid treatment medium 26 of the embodiment of FIG. 3. The first and second strips 72, 73 may be positioned along the support layer 70 coplanar with one another. In the illustrated embodiment, the first strip 72 may be arranged side edge by side edge in close proximity, e.g., in contact, with the second strip 73. In other embodiments, there may be a space or an intervening structure between the coplanar strips. For many embodiments, the thicknesses of the first and second strips 72, 73 may be substantially equal. The width of one of the first and second strips 72, 73 may be equal to or different from the width of the other strip. The width of each strip 72, 73 may be less than the width of the support layer 70, and the combined widths of the strips 72, 73 may be less than, approximately equal to, or greater than the width of the support layer 70.

The first and second strips 72, 73 may be arranged along the support layer 70 to define a series fluid pathway 27 generally edgewise through the strips. The fluid pathway may extend from the first side edge of the first strip 72 generally edgewise through the first strip 72 to the second side edge, and then into the first side edge of the second strip 73 and generally edgewise through the second strip 73 to the second side edge in a manner analogous to the fluid pathway 27 through the fluid treatment medium 26 of FIG. 3. For some embodiments, the fluid treatment characteristic of one of the strips, e.g., the first strip 72, may comprise a coarser removal rating or pore structure, and the fluid treatment characteristic of another of the strips, e.g., the second strip 73, may comprise a finer removal rating or pore structure. The first strip 72 may be arranged in the ribbon 20 upstream of the second strip 73. In some embodiments, the fluid treatment characteristic of one of the strips, e.g., the first strip 72, may comprise a removal rating or pore structure for removing particulates from a fluid. The fluid treatment characteristic of another of the strips, e.g., the second strip 73, may comprise a sorbent for sorbing one or more substances from the fluid. The first and second strips 72, 73 may directly contact the support layer 70 and may or may not be bonded to the support layer 70. Alternatively, the ribbon may include a separate bonding layer and/or other layers.

The ribbon may be spirally wound in a plurality of windings to form a fluid treatment element including a disk-shaped body having any desired radial dimension, as previously described with respect to the embodiment of FIG. 1. The disk-shaped body may include a feed side, a permeate side, and an outer rim, for example, similar to any of the embodiments shown in FIGS. 2, 4, 5, and 6. The feed side may comprise the plurality of windings of a side edge of one of the strips of fluid treatment media comprising the fluid treatment layer 71, and the permeate side may comprise the plurality of windings of a side edge of another of the strips of fluid treatment media comprising the fluid treatment layer 71.

Fluid treatment elements, which each incorporate multiple strips of fluid treatment having different fluid treatment characteristics arranged in series, may be positioned along a core assembly to form a fluid treatment arrangement in a variety of ways, for example, in a manner similar to the embodiment of FIG. 1 or 9. The fluid treatment arrangement may be enclosed in a housing to form a fluid treatment assembly in a variety of ways, for example, in a manner similar to the embodiment shown in FIG. 7. Fluid flowing through the fluid treatment assembly may flow axially through the fluid treatment elements along a fluid flow path between the exterior of the fluid treatment arrangement and the interior of the core assembly. As the fluid flows from the feed side to the permeate side of each fluid treatment element, the fluid may flow generally edgewise in series through at least a first permeable fluid treatment medium having a first fluid treatment characteristic, where the fluid is first treated in accordance with the first fluid treatment characteristic, and a second permeable fluid treatment medium having a second fluid treatment characteristic, where the fluid is then treated in accordance with the second fluid treatment characteristic.

As yet another example, some of the spaces between adjacent fluid treatment elements may be arranged to be fluidly isolated from both the interior of the core assembly and the exterior of the adjacent fluid treatment elements. For some embodiments, these intervening or intermediate spaces may be occupied by a functional material that has a different fluid treatment characteristic than the fluid treatment characteristic of either or both of the adjacent fluid treatment elements. For example, a portion of a fluid treatment arrangement 10 including spaced adjacent fluid treatment elements 12 having spirally wound disk-shaped bodies 21 and a core assembly 11 is shown in FIG. 11. The fluid treatment arrangement 10 may be similar to the fluid treatment arrangement 10 shown in FIG. 1. In FIG. 11, each of the fluid treatment elements 12 may comprise a ribbon 20 having a single fluid treatment medium 26 and all of the fluid treatment elements 12 may provide the same fluid treatment characteristic. Alternatively, one or more of the fluid treatment elements may comprise a ribbon similar to the ribbon shown in FIG. 10. The fluid treatment element may then provide first and second different fluid treatment characteristics in series. As yet another alternative, one or more of the fluid treatment elements may comprise a ribbon having first and second fluid treatment media with different fluid treatment characteristic layered as a composite, as shown in FIG. 3. The fluid treatment element may then provide first and second different fluid treatment characteristics in parallel.

The fluid treatment arrangement 10 of FIG. 11 may further include at least one intervening or intermediate space 80 in a fluid flow path between a feed space 13 and a permeate space 14. The intermediate space 80 may be isolated from the interior 15 of the core assembly 11, for example, by a solid wall portion of the core assembly 11. The intermediate space 80 may be fluidly isolated from the exterior of the fluid treatment elements 12 by a surround 36. For example, in addition to a perforated band 37A encircling the feed space 13 and an impermeable, imperforate band 37B encircling the permeate space 14, the surround 36 may include a band 37C, such as an impermeable, imperforate band, which encircles the outer end of the intermediate space 80 and is sealed to the outer rims 35 of the adjacent fluid treatment elements 12. At least the permeate space bands 37B and the intermediate space bands 37C may axially abut one another.

In the embodiment illustrated in FIG. 11, the fluid treatment elements 12 may all be arranged in a single set immediately adjacent to the core assembly 11, and the intermediate space 80 may be located between adjacent elements 12 in the single set. In other embodiments, such as an embodiment similar to the embodiment shown in FIG. 9, the fluid treatment elements may be arranged in multiple radially displaced sets, and the intermediate space may be located between adjacent pairs of radially displaced fluid treatment elements. For example, the combination of each outer space 64B and the inner space 62B into which it opens in the embodiment of FIG. 9 may be an intermediate space located between adjacent pairs of radially displaced fluid treatment elements in a fluid flow path between the exterior of the fluid treatment arrangement and the interior of the core assembly.

The intermediate space 80 may be occupied by a functional material 81 having a fluid treatment characteristic different from one or both of the adjacent fluid treatment elements. For example, the functional material may have any of the fluid treatment characteristics previously described with respect to the permeable fluid treatment medium of the embodiment shown in FIG. 1. Further, the functional material may be structured in a variety of ways, including, for example, as a bed of particles filling the space or a fibrous structure, such as a fibrous mass, sheet, or disk, inserted in the space. The functional material 81 may be positioned in the intermediate space 80 in a variety of ways. For example, the functional material 81 may be positioned in the space 80 with the band 37C around only a portion, e.g., 50% or more, of the outer perimeter of the space 80. Once the functional material 81 is in place within the space 80, the band 37C may be fixed completely around the space 80, sealing the functional material 81 within the space 80. Fluid flowing through the fluid treatment arrangement may then flow in series through at least one fluid treatment element which has a first fluid treatment characteristic and the functional material in the intermediate space which has a second different fluid treatment characteristic along a fluid flow path outside-in or inside-out between the exterior of the fluid treatment arrangement and the interior of the core assembly.

The present invention is thus not restricted to the particular embodiments which have been described and/or illustrated herein but includes all embodiments and modifications that may fall within the scope of the claims.

1. A fluid treatment arrangement comprising:
a hollow core assembly having an interior and an axis;
at least first and second fluid treatment elements mounted along the core assembly, wherein each fluid treatment element includes a ribbon which has a permeable fluid treatment medium and is spirally wound in a plurality of windings to define a generally disk-shaped body having a radial dimension, a first end surface on one side of the body, a second end surface on the other side of the body, and an outer rim, and wherein the first fluid treatment element has a first fluid treatment characteristic and the second fluid treatment element has a second fluid treatment characteristic, the second fluid treatment characteristic being different from the first fluid treatment characteristic; and
a fluid flow path which extends between the first and second end surfaces of both fluid treatment elements generally edgewise through the permeable fluid treatment media to or from the interior of the core assembly.

2-3. (canceled)

4. The fluid treatment arrangement of claim 1 wherein the permeable fluid treatment medium of the first fluid treatment element includes the first fluid treatment characteristic and the permeable fluid treatment medium of the second fluid treatment element includes the second fluid treatment characteristic.

5-6. (canceled)

7. The fluid treatment arrangement of claim 1 further comprising a plurality of first fluid treatment elements mounted along the core assembly, a plurality of second fluid treatment elements mounted along the core assembly, and spaces between at least some adjacent fluid treatment elements, wherein the core assembly has an opening and the at least one of the spaces opens directly into the interior of the core assembly via the opening and wherein the fluid treatment arrangement further comprises a surround which encircles the space and fluidly blocks an outer end of the space.

8. The fluid treatment arrangement of claim 1 further comprising a plurality of first fluid treatment elements mounted along the core assembly, a plurality of second fluid treatment elements mounted along the core assembly, and spaces between at least some adjacent fluid treatment elements, wherein at least one of the spaces opens directly onto the exterior of the adjacent fluid treatment elements.

9. (canceled)

10. A fluid treatment arrangement of claim 1 wherein the first fluid treatment characteristic comprises a first removal rating and the second fluid treatment characteristic comprises a second removal rating.

11. (canceled)

12. A fluid treatment arrangement of claim 1 wherein one of the first and second fluid treatment characteristics comprises a removal rating and the other of the first and second fluid treatment characteristics comprises a functional material.

13. (canceled)

14. A fluid treatment assembly comprising a housing and a fluid treatment arrangement of claim 1 disposed inside the housing, wherein the housing has first and second ports and defines a fluid flow path between the first and second ports, wherein the fluid treatment arrangement is positioned in the housing across the fluid flow path between the first and second ports, and wherein the fluid flow path of the fluid treatment arrangement comprises a portion of the fluid flow path between the first and second ports.

15. A fluid treatment arrangement comprising:
a hollow core assembly having an interior and an axis; and
a plurality of disk-shaped fluid treatment elements, wherein each fluid treatment element includes a ribbon which has at least one strip of a permeable fluid treatment medium having first and second opposite side edges, wherein the ribbon is spirally wound in a plurality of windings and defines a first axially-facing end surface comprising a plurality of windings of the first side edge of the permeable fluid treatment medium strip, a second axially-facing end surface comprising a plurality of windings of the second side edge of the permeable fluid treatment medium strip, and an outer rim, wherein the plurality of fluid treatment elements includes a plurality of first fluid treatment elements having a first fluid treatment characteristic and a plurality of second fluid treatment elements having a second fluid treatment characteristic different from the first fluid treatment characteristic, and wherein the plurality of fluid treatment elements are positioned along the core assembly to define a plurality of spaces between at least some adjacent fluid treatment elements, the plurality of spaces including a plurality of first spaces which open directly into the interior of the core assembly and a plurality of second spaces which open directly onto the exterior of the fluid treatment arrangement.

16-17. (canceled)

18. The fluid treatment arrangement of claim 15 wherein the permeable fluid treatment medium strip of each first fluid treatment element includes the first fluid treatment characteristic and the permeable fluid treatment medium strip of each second fluid treatment element includes the second fluid treatment characteristic.

19-24. (canceled)

25. A fluid treatment arrangement of claim 15 further comprising a surround positioned around the first spaces to block the outer ends of the first spaces.

26. A fluid treatment assembly comprising a housing and a fluid treatment arrangement of claim 15 disposed in the housing, wherein the housing has first and second ports and defines a fluid flow path between the first and second ports, the fluid treatment arrangement being positioned in the housing with the fluid treatment elements disposed across the fluid flow path.

27. A fluid treatment element comprising a ribbon spirally wound in a plurality of windings to define a generally disk-shaped body having a radial dimension, a first end surface on one side of the body, a second end surface on the other side of the body, and an outer rim, wherein the ribbon includes a multilayer composite comprising first and second superposed layers, wherein the first layer comprises at least first and second generally coplanar strips of fluid treatment media arranged along the second layer, and wherein the first strip of the fluid treatment medium has a first fluid treatment characteristic and the second strip of the fluid treatment medium has a second fluid treatment characteristic different form the first fluid treatment characteristic.

28. The fluid treatment element of claim 27 wherein the width of each of the first and second strips is less than the width of the second layer.

29-33. (canceled)

34. A method for making a fluid treatment arrangement comprising:
positioning along a hollow core assembly a first spirally wound, disk-shaped fluid treatment element having a first fluid treatment characteristic and a second spirally wound, disk-shaped fluid treatment element having a second fluid treatment characteristic which is different from the first fluid treatment characteristic, wherein positioning the first and second fluid treatment elements along the core assembly includes arranging the first and second fluid treatment elements in a fluid flow path which extends generally edgewise through the windings of the first and second fluid treatment elements in series to or from the interior of the core assembly.

35. A method of claim 34 further comprising spirally winding a first ribbon which includes a permeable fluid treatment medium having the first fluid treatment characteristic in a plurality of windings to form the first fluid treatment element, and spirally winding a second ribbon which includes a permeable fluid treatment medium having the second fluid treatment characteristic in a plurality of windings to form the second fluid treatment element.

36. A method of claim 35 wherein spirally winding the first ribbon, spirally winding the second ribbon, and positioning the first and second fluid treatment elements around the core assembly include spirally winding the first ribbon around the core assembly at a first location along the core assembly and spirally winding the second ribbon around the core assembly at a second location along the core assembly.

37-40. (canceled)

41. A method for making a fluid treatment element comprising:
superposing first and second layers to form a ribbon, including positioning a first strip of a permeable fluid treatment medium having a first fluid treatment characteristic generally coplanar with a second strip of a permeable fluid treatment medium having a second fluid treatment characteristic different from the first fluid treatment characteristic to form the first layer and
winding the ribbon in a plurality of windings to form a disk-shaped fluid treatment element having first and second axially-facing end surfaces and an outer rim.

42. (canceled)

43. A method of treating a fluid comprising:
directing a fluid generally edgewise through windings of a first spirally wound strip of a permeable fluid treatment medium having a first fluid treatment characteristic and then
directing the fluid generally edgewise through windings of a second spirally wound strip of a permeable fluid treatment medium having a second fluid treatment characteristic which is different from the first fluid treatment characteristic.

44. (canceled)

45. A fluid treatment arrangement comprising:
a hollow core assembly having an interior and an axis;
at least first and second fluid treatment elements mounted along the core assembly, wherein each fluid treatment element includes a ribbon which has a permeable fluid treatment medium and is spirally wound in a plurality of windings to define a generally disk-shaped body having a radial dimension, a first end surface on one side of the body, a second end surface on the other side of the body, and an outer rim and wherein at least one of the first and second fluid treatment elements has a first fluid treatment characteristic;
a space adjacent to at least one of the first and second fluid treatment elements, wherein the space is isolated from the interior of the core assembly and exterior of the fluid treatment arrangement;
a functional material disposed in the space, wherein the functional material has a second fluid treatment characteristic which is different from the first fluid treatment characteristic; and
a fluid flow path which extends in series through the fluid treatment element having the first fluid treatment characteristic and the functional material having the second fluid treatment characteristic to or from the interior of the core assembly.

46-47. (canceled)

48. The fluid treatment arrangement of claim 45 wherein the functional material comprises a bed of particles.

49. (canceled)
